(19) United States
(12) Patent Application Publication
(10) Pub. No.: US 2004/0049767 A1
(43) Pub. Date: Mar. 11, 2004

(54) Method and apparatus for comparing computer code listings

(75) Inventor: Charles Gordon Hooks, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 10/235,603

(22) Filed: Sep. 5, 2002

(51) Int. Cl. G06F 9/44

(52) U.S. Cl. 717/122; 717/126

(57) ABSTRACT

A method and apparatus for the comparison of two code listings. The process allows for comparing of multiple lines of code in a code listing when determining whether the code from a first code listing matches the code in a second code listing to determine lines that have been deleted or inserted. The first code listing is referred to as the old code listing and the second code listing is referred to as the new code listing. The process performs a series of comparisons instead of single comparison when looking for a match. The result is a more accurate set of comparison results than with a single comparison.

### BACKGROUND OF THE INVENTION

1. Technical Field

The present invention relates generally to an improved data processing system, and in particular, to a method and apparatus for processing data. Still more particularly, the present invention provides a method and apparatus for comparing listings of computer code.

2. Description of Related Art

A program is a collection of instructions that tell the computer what to do. A program is called “software” and programs that users work with, such as word processors and spreadsheets, are called “applications” or “application programs”. A program is written in a programming language, such as Visual Basic, C or C++, and the statements and commands written by the programmer are converted into the computer's machine language by software called “assemblers”, “compilers”, and “interpreters”.

In developing programs or software, the programmer typically generates several versions of a program in the process of developing a final product. Often times in writing a new version of a program, a programmer may desire to locate differences between the versions. The programmer may compare the source files of the two different versions looking at the new code listing and the old code listing to identify differences in-lines of code between the two code listings. Typically, the programmer will place the old code listing on one side and the new code listing next to it. The programmer will compare lines of code by moving his or her hands to mark lines for comparison. The programmer will move down the lines in the two code listings until a match does not occur. When a mismatch between the lines in the code listings is identified, the programmer will move down the new listing while holding the place in the old code listing, looking for a match to the line in the old code listing. If a match is found, then the programmer assumes that additional lines have been added to the new code listing.

If no match occurs while moving down the new listing and while holding the old, then the programmer holds at the current line in the new code listing and moves down the old code listing looking for a matching line. If a match occurs, then it is assumed that lines have been deleted from the old listing to make the new listing. If no match occurs, then it is assumed that the line in the old code listing is replaced by the line in the new code listing. The programmer will move down to the next line of each code listing and repeat the comparison process.

Currently, this process results in an inaccuracy in correctly matching code listings. The fact that statements containing loops and/or if-then-else constructs in multiple nestings have the same end statements. As a result, the first occurrence of an assumed match may not be the right line. Therefore, it would be advantageous to have an improved method, apparatus, and computer instructions for accurately comparing code listings between different versions of a computer program.

### SUMMARY OF THE INVENTION

The present invention provides a method, apparatus, and computer instructions for comparing programs. The present invention provides for allowing the specification or selection that several consecutive lines are required to match for the match to be a true match. A current line in a first code listing is compared to a current line in a second code listing. A next line in the second code listing is selected as the current line in the second code listing and the comparing step is repeated in response to an absence of a match between the current line in the first code listing to the current line in the second code listing. A determination is made as to whether a set of additional consecutive lines match between the first code listing and the second code listing in response to a match between the current line in the second code listing to the current line in the first code listing after a next line in the second code listing has been selected as the current line. The set of lines are identified as an addition to the second code listing if a match in the set of additional lines between the first code listing and the second code listing is present if the first code listing is an older code listing than the second code listing. The set of lines are identified as a deletion to the second code listing if a match in the set of additional lines between the first code listing and the second code listing is present if the second code listing is an older code listing than the first code listing.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system is shown in which the present invention may be implemented; and

FIGS. 3A and 3B depict the flow of the Matching Process (MP); and

FIG. 4 is a diagram illustrating sample code on which the process of the present invention may be used in accordance with a preferred embodiment of the present invention.

### DETAILED DESCRIPTION OF THE PREFERRED EMBODIMENT

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

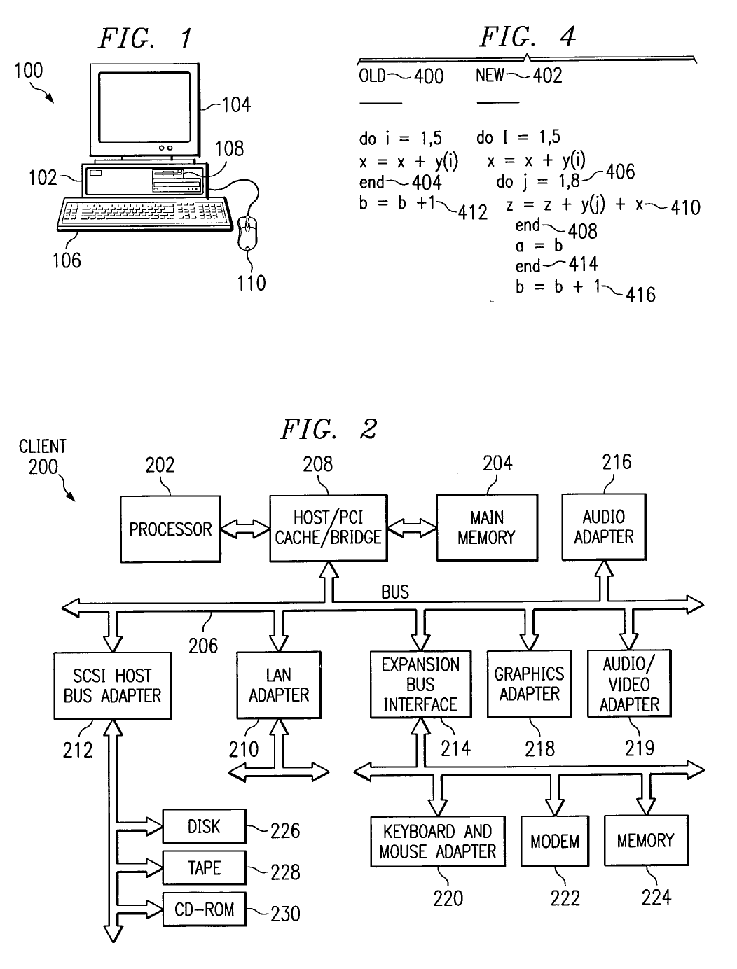

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

The present invention provides an improved method, apparatus, and computer instructions for comparing instructions or lines of code in two versions of a computer program. The mechanism of the present invention provides a more accurate matching or comparison process by allowing the designation that not just one but several consecutive lines must match for the match to be true. The number of consecutive lines selected may vary with the coding standards and the programming language. The use of requiring a match in some selected number of consecutive statements helps guarantee an accurate match and allows the mechanism of the present invention to recognize the multiple end statements and make adjustments.

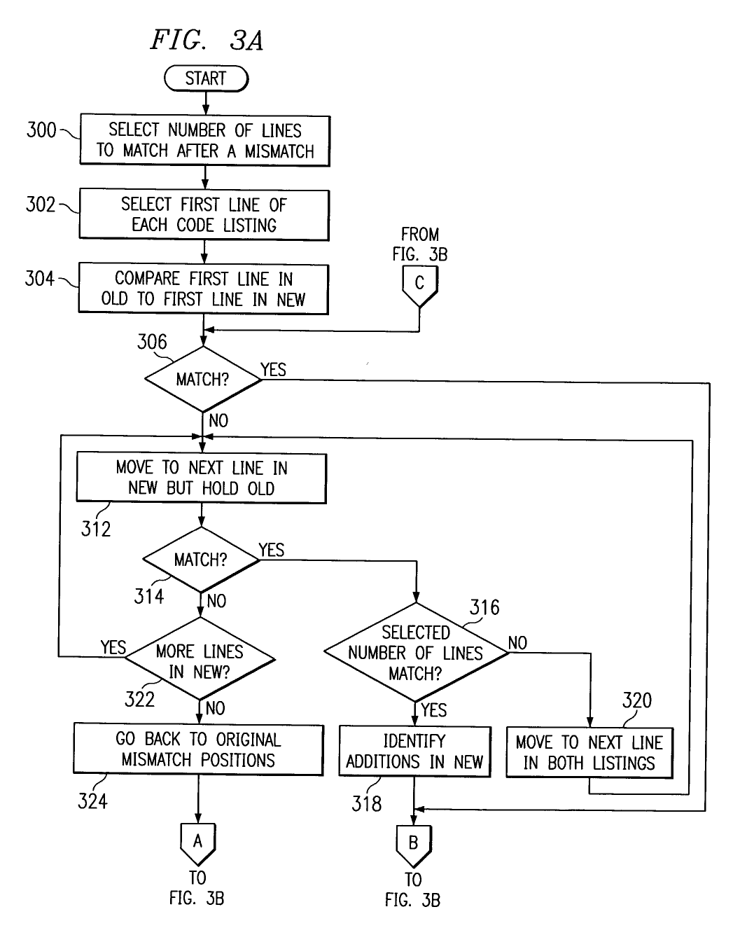

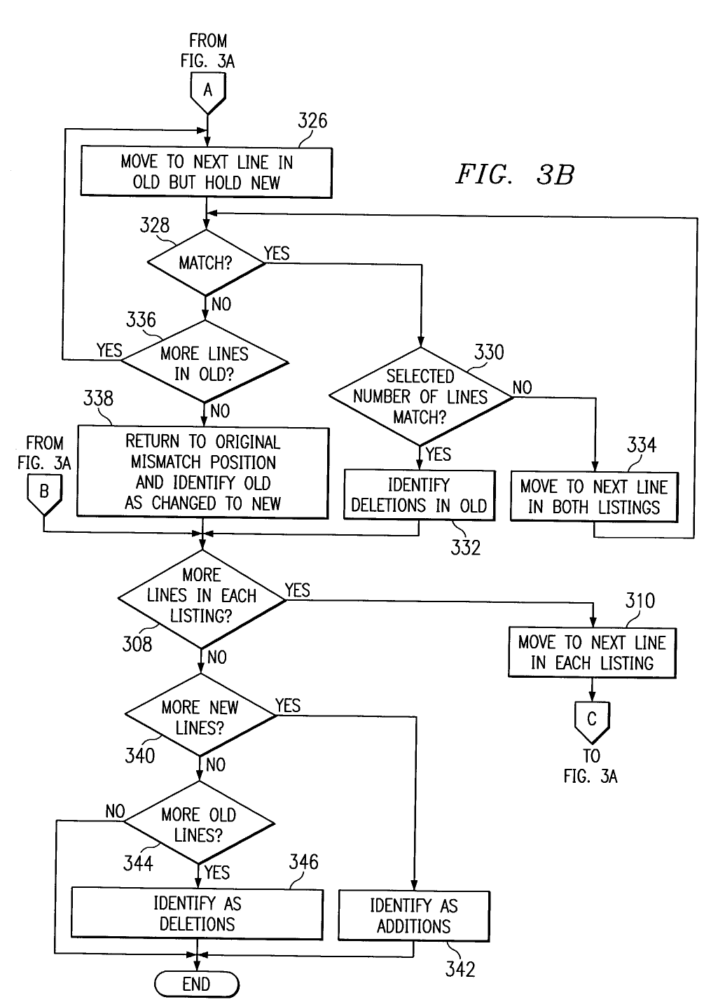

FIGS. 3A and 3B depict the flow of the Matching Process (MP). The Matching Process starts the process. A number of lines to substantiate a match after a mismatch is stored for use in determining whether a match meets the criteria (step 300). This number may be preselected or input by a user. The number of lines selected depends on the particular implementation. The number of lines may vary depending on the coding standards and the particular programming language. For example, the number of lines may be one, two, three, or four. For code where after the end of a loop or some other block of code there is always some repetitive set of one or two statements at the end, a need exists for a matching requirement of three or four lines of statements to be back at a true match. In today's languages for HTML, Java, and VB, a need exists even more for multiple matches because of the beginning and closing statements for a block. The process of comparison then begins with selecting the first line of the old code listing and new code listing (step 302). The lines in each listing are compared (304). A determination is then made as to whether a match is present between the first line in the old code listing and the first line in the new code listing (step 306). If there is a match, a check is made to see if more unprocessed or unchecked lines are present in each code listing (step 308). If more unchecked or unprocessed lines are present, the process selects or moves to the next line in both code listings (step 310) with the process returning to step 306 as described above. These steps of matching and moving to the next line are repeated as long as the lines match.

With reference again to step 306, if the lines do not match, the process stays at or holds on the line in the old code listing and moves to the next line in the new code listing (step 312). These two lines are the lines currently selected for comparison. A test is performed to determine whether a match is present between the currently selected lines (step 314). If a match is present, a determination is made as to whether the selected number of lines stored in step 300 match between the two code listings after the occurrence of the mismatch (step 316).

If the selected number of lines match between the two code listings, then the lines found in the new code listing are identified as additions to the new code listing (step 318). Thereafter, the process returns to step 308 to continue the search for matches between the code listings as described in steps 308 and 310.

With reference again to step 316, if the selected number of lines for a match has not been reached, then the process moves to or selects the next line in each code listing for processing (step 320) with the process then returning to step 312 to test for a match again. Steps 314, 316, and 320 are repeated until the selected set has matched or a mismatch occurs. In step 322, if more lines are present in the new code listing, the process returns to step 312 with these steps being repeated until a match is confirmed or the number of unprocessed lines in the new code listing becomes exhausted.

When the number of unprocessed lines in the new codes listing is identified as being exhausted in step 322, the process then returns to the original place in the code listings where the mismatch occurred (step 324). After returning to the place in the code listings in which the mismatch occurred, the process moves to or selects the next line in the old code listing, while holding the line in the new code listing (step 326).

Next, a determination is made as to whether a match between the currently selected lines in the code listings is present (step 328). If a match occurs, then a determination is made as to whether the number of lines stored in step 300 match between the two code listings after the mismatch (step 330). If the number of lines match, then these lines are assumed to be deletions from the old code listing (step 332) with the process then returning to steps 308 and 310 as described above to continue the search.

If the selected number of lines for a match has not been reached, the process then selects or moves to the next line in each listing (step 334) with the process then returning to step 328 to test for a match between the currently selected lines in each of the code listings. Steps 328, 330, and 334 are repeated until the number of lines selected for matching has matched or a mismatch occurs. When a mismatch occurs in step 328, a determination is then made as to whether additional unprocessed lines are present in the old code listing (step 336). If additional unprocessed lines are present in the old code listing, the process returns to step 326 with these steps being repeated until a match is confirmed or the number of unprocessed lines in the old code listing is exhausted.

When the number of unprocessed lines in the old code listing is exhausted, the process returns to the original place in the code listings where the mismatch occurred and the line in the old code line is identified as having been changed with respect to the line in the new code listing (step 338). The process then proceeds to check for additional lines in each code listing and to move to the next line in each code listing (step 310) with the process then returning to step 306 as described above.

If additional unprocessed lines are not present in both of the code listings in step 308, a determination is made as to whether the new code listing has more unprocessed lines (step 340). If additional unprocessed lines are present in the code listing, these lines are identified as additions (step 342) with the process terminating thereafter. If in step 340, the new code listing does not have additional unprocessed lines, a determination is made as to whether the old code listing contains unprocessed lines (step 344). If additional unprocessed lines are present in the old code listing, these lines are identified as deletions made to the new code listing (step 346) with the process terminating thereafter. Turning back to step 344, if additional unprocessed lines are not present in the old code listing, the process terminates.

Turning next to FIG. 4, a diagram illustrating sample code on which the process of the present invention may be used is depicted in accordance with a preferred embodiment of the present invention. Specifically, old code 400 and new code 402 are examples of code that may be processed using the steps illustrated in FIGS. 3A and 3B above. If the comparison between old code 400 and new code 402 were to be performed using presently available matching systems, only one line, then a mismatch would occur at lines 404 and 406 between old code 400 and new code 402. This mismatch would show that the match when holding old code 400 at line 404 and line 408 in new code 402. In this case, lines 406 and 410 in new code 402 are additions.

On the other hand, if the matching process used two lines, then line 404 and line 412 in old code 400 would match lines 414 and 416 in new code 402. In this case, the new additions found between the mismatch and the matches would be correct. If a single line process were used, the right lines would show all as added but as two groups of lines not as one when two lines are used in performing the matching process.

Thus, the present invention provides an improved method, apparatus, and computer instructions for comparing code listings. Specifically, the mechanism of the present invention allows for the comparing of multiple lines of code in a code listing when determining whether the code from a first code listing matches the code in a second code listing to determine lines that have been deleted or inserted. The first code listing is referred to as the old code listing and the second code listing is referred to as the new code listing. The process performs a series of comparisons instead of a single comparison when looking for a match. The result is a more accurate set of comparison results than with a single comparison.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for comparing programs, the method comprising:
comparing a current line in a first code listing to a current line in a second code listing;
responsive to an absence of a match between the current line in the first code listing to the current line in the second code listing, selecting a next line in the second code listing as the current line in the second code listing and repeating the comparing step;
responsive to a match between the current line in the second code listing to the current line in the first code listing after a next line in the second code listing has been selected as the current line, determining whether a set of additional lines match between the first code listing and the second code listing;
identifying the set of lines as an addition to the second code listing if a match in the set of additional lines between the first code listing and the second code listing is present if the first code listing is an older code listing than the second code listing; and
identifying the set of lines as a deletion to the second code listing if a match in the set of additional lines between the first code listing and the second code listing is present if the second code listing is an older code listing than the first code listing.

2. The method of claim 1, wherein the addition is a nested loop within the second code listing.

3. The method of claim 1, wherein the deletion is a nested loop within the second code listing.

4. A method in a data processing system for comparing code listings, the method comprising:
selecting a first line in a first code listing and a first line in a second code listing;
comparing the first line in a first code listing to the first line in a second code listing to form a comparison;
responsive to an absence of a match in the comparison, selecting a next line in the second code listing as a current line in the second code listing and holding the first line in the first code listing as a current line;
comparing the current line in the first code listing to the current line in the second code listing;
responsive to a match between the current line in the first code listing to the current line in the second code listing, determining whether a set of additional lines after the current line in the first code listing and the current line in the second code listing match; and
responsive to a match in the set of additional lines, identifying the set of lines as an addition to the second code listing.

5. The method of claim 4 further comprising:
responsive to a match in the set of additional lines, identifying the set of lines in the second code listing as new additions to the second code listing.

6. The method of claim 4 further comprising:
responsive to an absence of a match in the set of additional lines, identifying new lines by selecting a next line after the current line as the current line in the first code listing and a next line after the current line as the current line in the second code listing; and
after identifying the new lines, repeating the comparing step.

7. The method of claim 4 further comprising:
responsive to an absence of a match, determining whether an additional uncompared line is present in the second code listing; and
responsive to a determination that an additional uncompared line is present in the second code listing, repeating the step of selecting a next line in the second code listing as a current line in the second code listing and holding the first line in the first code listing as a current line.

8. The method of claim 4 further comprising:
responsive to an absence of a match, determining whether an additional uncompared line is present in the second code listing;
responsive to an absence of an additional uncompared line in the second code listing, returning to a first selected line where a mismatch occurred in the first code listing and to a second selected line where a mismatch occurred in the second code listing;
identifying a next line after the selected line in the first code listing;
comparing the next line in the first code listing to the selected line in the second code listing;
responsive to a match between the next line and the selected line, determining whether a set of additional lines after the next line in the first code listing and the selected line in the second code listing match; and
responsive to a match in the set of additional lines after the next line in the first code listing and the selected line in the second code listing, identifying the set of additional lines as deletions in the first listing.

9. A data processing system for comparing programs, the data processing system comprising:
a bus system;
a communications unit connected to the bus system;
a memory connected to the bus system, wherein the memory includes a set of instructions; and
a processing unit connected to the bus system, wherein the processing unit executes the set of instructions to compare a current line in a first code listing to a current line in a second code listing; select a next line in the second code listing as the current line in the second code listing and repeat the instructions to compare in response to an absence of a match between the current line in the first code listing to the current line in the second code listing; determine whether a set of additional lines match between the first code listing and the second code listing in response to a match between the current line in the second code listing to the current line in the first code listing after a next line in the second code listing has been selected as the current line; identify the set of lines as an addition to the second code listing if a match in the set of additional lines between the first code listing and the second code listing is present if the first code listing is an older code listing than the second code listing; and identify the set of lines as a deletion to the second code listing if a match in the set of additional lines between the first code listing and the second code listing is present if the second code listing is an older code listing than the first code listing.

10. A data processing system for comparing code listings, the data processing system comprising:
a bus system;
a communications unit connected to the bus system;
a memory connected to the bus system, wherein the memory includes a set of instructions; and
a processing unit connected to the bus system, wherein the processing unit executes the set of instructions to select a first line in a first code listing and a first line in a second code listing; compare the first line in a first code listing to the first line in a second code listing to form a comparison; select a next line in the second code listing as a current line in the second code listing and holding the first line in the first code listing as a current line in response to an absence of a match in the comparison; compare the current line in the first code listing to the current line in the second code listing; determine whether a set of additional lines after the current line in the first code listing and the current line in the second code listing match in response to a match between the current line in the first code listing to the current line in the second code listing; and identify the set of lines as an addition to the second code listing in response to a match in the set of additional lines.

11. A data processing system for comparing programs, the data processing system comprising:
comparing means for comparing a current line in a first code listing to a current line in a second code listing;
selecting means, responsive to an absence of a match between the current line in the first code listing to the current line in the second code listing, for selecting a next line in the second code listing as the current line in the second code listing and repeating initiation of the comparing means;
determining means, responsive to a match between the current line in the second code listing to the current line in the first code listing after a next line in the second code listing has been selected as the current line, for determining whether a set of additional lines match between the first code listing and the second code listing;
first identifying means for identifying the set of lines as an addition to the second code listing if a match in the set of additional lines between the first code listing and the second code listing is present if the first code listing is an older code listing than the second code listing; and
second identifying means for identifying the set of lines as a deletion to the second code listing if a match in the set of additional lines between the first code listing and the second code listing is present if the second code listing is an older code listing than the first code listing.

12. The data processing system of claim 11, wherein the addition is a nested loop within the second code listing.

13. The data processing system of claim 11, wherein the deletion is a nested loop within the second code listing.

14. A data processing system for comparing code listings, the data processing system comprising:
first selecting means for selecting a first line in a first code listing and a first line in a second code listing;
first comparing means for comparing the first line in a first code listing to the first line in a second code listing to form a comparison;
second selecting means, responsive to an absence of a match in the comparison, for selecting a next line in the second code listing as a current line in the second code listing and holding the first line in the first code listing as a current line;
second comparing means for comparing the current line in the first code listing to the current line in the second code listing;
determining means, responsive to a match between the current line in the first code listing to the current line in the second code listing, for determining whether a set of additional lines after the current line in the first code listing and the current line in the second code listing match; and
identifying means, responsive to a match in the set of additional lines, for identifying the set of lines as an addition to the second code listing.

15. The data processing system of claim 14, wherein the identifying means is a first identifying means and further comprising:
second identifying means, responsive to a match in the set of additional lines, for identifying the set of lines in the second code listing as new additions to the second code listing.

16. The data processing system of claim 14, wherein the identifying means is a first identifying means further comprising:
third identifying means, responsive to an absence of a match in the set of additional lines, for identifying new lines by selecting a next line after the current line as the current line in the first code listing and a next line after the current line as the current line in the second code listing; and
repeating means, after identifying the new lines, for repeating the comparing step.

17. The data processing system of claim 14, wherein the determining means is a first determining means, the repeating means is a first repeating means, and further comprising:
second determining means, responsive to an absence of a match, for determining whether an additional uncompared line is present in the second code listing; and
second repeating means, responsive to a determination that an additional uncompared line is present in the second code listing, for repeating the step of selecting a next line in the second code listing as a current line in the second code listing and holding the first line in the first code listing as a current line.

18. The data processing system of claim 14, wherein the determining means is a first determining means, the identifying means is a first identifying means, and further comprising:
second determining means, responsive to an absence of a match, for determining whether an additional uncompared line is present in the second code listing;
returning means, responsive to an absence of an additional uncompared line in the second code listing, for returning to a first selected line where a mismatch occurred in the first code listing and to a second selected line where a mismatch occurred in the second code listing;
fourth identifying means for identifying a next line after the selected line in the first code listing; comparing means for comparing the next line in the first code listing to the selected line in the second code listing;
third determining means, responsive to a match between the next line and the selected line, for determining whether a set of additional lines after the next line in the first code listing and the selected line in the second code listing match; and
fifth identifying means, responsive to a match in the set of additional lines after the next line in the first code listing and the selected line in the second code listing, for identifying the set of additional lines as deletions in the first listing.

19. A computer program product in a computer readable medium for comparing programs, the computer program product comprising:
first instructions for comparing a current line in a first code listing to a current line in a second code listing;
second instructions, responsive to an absence of a match between the current line in the first code listing to the current line in the second code listing, for selecting a next line in the second code listing as the current line in the second code listing and repeating the comparing step;
third instructions, responsive to a match between the current line in the second code listing to the current line in the first code listing after a next line in the second code listing has been selected as the current line, for determining whether a set of additional lines match between the first code listing and the second code listing;
fourth instructions for identifying the set of lines as an addition to the second code listing if a match in the set of additional lines between the first code listing and the second code listing is present if the first code listing is an older code listing than the second code listing; and
fifth instructions for identifying the set of lines as a deletion to the second code listing if a match in the set of additional lines between the first code listing and the second code listing is present if the second code listing is an older code listing than the first code listing.

20. A computer program product in a computer readable medium for comparing code listings, the computer program product comprising:
first instructions for selecting a first line in a first code listing and a first line in a second code listing;
second instructions for comparing the first line in a first code listing to the first line in a second code listing to form a comparison;
third instructions, responsive to an absence of a match in the comparison, for selecting a next line in the second code listing as a current line in the second code listing and holding the first line in the first code listing as a current line;
fourth instructions for comparing the current line in the first code listing to the current line in the second code listing;
fifth instructions, responsive to a match between the current line in the first code listing to the current line in the second code listing, for determining whether a set of additional lines after the current line in the first code listing and the current line in the second code listing match; and
sixth instructions, responsive to a match in the set of additional lines, for identifying the set of lines as an addition to the second code listing.
